(19) United States
(12) Patent Application Publication
(10) Pub. No.: US 2011/0069070 A1
(43) Pub. Date: Mar. 24, 2011

(54) EFFICIENT VISUALIZATION OF OBJECT PROPERTIES USING VOLUME RENDERING

(76) Inventor: KLAUS ENGEL, Nurnberg (DE)

(21) Appl. No.: 12/881,798

(22) Filed: Sep. 14, 2010

(30) Foreign Application Priority Data
Sep. 21, 2009 (DE) 10 2009 042 327.3

(51) Int. Cl. G06T 15/50

(52) U.S. Cl. 345/426; 382/128

(57) ABSTRACT

A method for the visualization of an object using simulated radiation includes using a representation of the object, in which values of a variable that characterizes the object are given at spatial points in the object. A first ray is generated to determine a pixel color value assigned to a pixel for a two-dimensional representation of the object. The first ray is propagated through at least a part of the object. The method also includes determining, step-by-step, values of a variable on the first ray and detecting a surface of the object using the values determined on the first ray. At least one second ray is generated for determining a quantitative value that characterizes a property of the object, and the at least one second ray is propagated away from the surface, through at least a part of the object. The method also includes determining, step-by-step, values associated with the variable on the at least one second ray, determining the quantitative value that characterizes the property of the object using the at least one second ray, assigning a color value in accordance with the quantitative value, and using the color value to determine the pixel color value.

This application claims the benefit of DE 10 2009 042 327.3, filed Sep. 21, 2009.

### BACKGROUND

The present embodiments relate to a method and a device for the visualization of an object using simulated radiation.

The present embodiments are in the field of volume rendering (i.e., the display or visualization of three-dimensional bodies or objects). The modeling, reconstruction or visualization of three-dimensional objects has a wide range of applications in the fields of medicine (e.g., CT, PET, MR, ultrasound), physics (e.g., electronic structure of large molecules) or geophysics (e.g., nature and position of layers of the earth). The object to the investigated may be irradiated (e.g., using electro-magnetic waves or sound waves) to investigate the nature of the object. The scattered radiation is detected, and the properties of the body are determined from the values detected. The result may consist of a physical variable (e.g., density, proportions of tissue components, elasticity, speed), the value of which is determined for the body. A virtual grid, on the grid points of which the values of the variable are determined, may be used. The grid points, or the values of the variable at the grid points, may be voxels. The voxels may be in the form of gray values.

Using volume rendering, a three-dimensional representation of the object or body under investigation is generated on a two-dimensional display surface (e.g., a screen). In doing so, pixels are generated from the voxels (e.g., with an intermediate stage of object points obtained from the voxels by interpolation), from which the image for the two-dimensional image display is composed. In order to visualize three dimensions on a two-dimensional display, alpha compositing or alpha decomposition may be undertaken. With this standard method, colors and also transparency values (e.g., values for the lack of transparency or opacity, which express respectively the transparency or the ability to obscure, of the various layers of the body) are assigned to voxels or to volume points generated from the voxels. Three colors in the form of a three-tuple, which encodes the proportions of the colors red, green and blue (e.g., the RGB value), and an alpha value that parameterizes the opacity may be assigned to an object point. Together these quantities form an RGBA color value, which is combined or mixed with the color values of other object points to form a color value for the pixel (e.g., for the visualization of partially transparent objects by alpha blending).

For the assignment of an appropriate color value, an illumination model may be used. The illumination model takes into account light effects (e.g., reflections of the light from surfaces of the object, which may be the external surface or the surfaces of internal layers of the object under investigation) with a modeled or simulated illumination of the object for visualization.

In the literature, there is a range of illumination models that are used. The Phong model or the Blinn-Phong model may be used.

Ray-casting (e.g., the simulation of incident light for illustrating or visualizing the body) may be used for volume rendering. With ray-casting, imaginary beams that originate from the eye of an imaginary viewer are transmitted through the body or object under investigation. For sample points along the imaginary beams, RBGA values are determined from the voxels and are combined to form pixels for a two-dimensional image using alpha compositing or alpha blending. Illumination effects may be taken into account by one of the illumination models discussed above, as part of a “shading” method.

Certain geometric variables (e.g., the wall thickness, separation distances or radii within an object under investigation) may be determined in advance (e.g., as part of a pre-processing procedure), before ray-casting is carried out for image calculation. For example, Luerig et al. use morphological operators as part of a pre-processing activity to calculate the diameter of structures in “Hierarchical volume analysis and visualization based on morphological operators,” IEEE Visualization (1998): 335-41. Knorpp et al. search for opposing points along a perpendicular to the surface for surfaces of a volume in EP 20010120835. Reinhart et al. use a pre-processing step, in which a local search is used within spherical regions around material interfaces to find regions where two neighboring interfaces between air and material occur in “Modem Voxel Based Data and Geometry Analysis Software Tools for Industrial CT,” Proc. 16th World Conference on NDT (2004).

The results (e.g., object structures) of pre-processing methods of this type may be stored in a data structure derived from the three-dimensional representation of the object (e.g., in a secondary representation or a secondary volume, to which reference is made when rendering the primary volume to color surfaces to correspond with the size of structures in the object).

More efficient methods for taking into account the properties of an object, such as geometric structures, during volume rendering are needed. Appropriate volume rendering may be carried out so efficiently that an object may be manipulated interactively (e.g., rotate, color in differently). Accordingly, the rendering may be carried out again, with a redetermination of geometric structures.

### SUMMARY AND DESCRIPTION

The present embodiments may obviate one or more of the drawbacks or limitations in the art. For example, rendering of an object may be made more flexible and more efficient.

The present embodiments relate to the visualization of an object using simulated radiation (e.g., ray casting). The term “object” is to be interpreted broadly. The object may include a number of items that are investigated jointly using the methods of the present embodiments. Linked or joined items are investigated, for example using rays (e.g., a first or a second ray as described below) that propagate from one item into the others. The object may be of a practically arbitrary nature. For example, the methods of the present embodiments are suitable for the investigation of materials and for medical imaging.

A representation of the object, in which scalar values (e.g., gray values) of a variable that characterizes the object are given at spatial points in the object (e.g., a three-dimensional image or a volume representation) is produced. The characterizing variable is, for example, a physical variable that has been determined using a measurement method (e.g., by computed tomography or nuclear magnetic resonance tomography). The characterizing variable may be, for example, a density (e.g., the density of the tissue or the proportion of hydrogen in nuclear magnetic resonance tomography).

The present embodiments are aimed at a two-dimensional representation of the object or of properties of the object (e.g., the generation of a two-dimensional image). The two-dimensional representation is made up of pixels. The methods of the present embodiments that are described below for one pixel may be carried out for all the pixels of the two-dimensional image of the object.

A color value is determined for the display of a pixel. The color value may be encoded in the form of an RGB value (e.g., by the contributions of the colors red, green and blue). “Color value” may cover any encoding of a color value. In one embodiment, various color values may be combined into one pixel color value (e.g., during alpha compositing or alpha blending). For this purpose, alpha values, which represent a measure of the opacity of the respective point, may be used. 4-tuples (e.g., RGBA), which contain not only the colors but also an alpha value, may be used. “Color value” may also cover an item of opacity or transparency information or an alpha value. Values of this sort may be used when combining several color values into one. In the embodiments, in which color values are combined, the determination of color value data may also include data on the opacity or transparency.

In one embodiment of a method for generating images from volume data, a first ray is generated to determine a pixel color value assigned to a pixel for a two-dimensional representation of the object (or object properties). The first ray is propagated through at least a part of the object, where step-by-step values are determined on the first ray for the characteristic variable (e.g., density data represented as gray values). During the propagation, at the sample points along the first ray, a color value (e.g., an RGBA value) may be assigned to the values determined (e.g., using a transfer function). In addition, shading may also be effected at these points (e.g., using a local illumination model).

In the course of the propagation of the first ray, a surface on the object is detected using the values determined on the first ray. The surface on the object may be an external or an internal surface of the object (e.g., an internal surface may be the meeting of different material or tissue layers). The detection of a surface may includes the determination of the point of intersection of the ray with the surface. By using, for example, nested intervals, more refined detection of the surface in terms of the step size used in the propagation of the first ray may be effected.

A second ray or a plurality of second rays is generated. The second ray is used to determine a quantitative value that characterizes a property of the object. The property of the object may be a geometric property (e.g., the thickness of a material or tissue layer bordering on the surface, or a measure of density fluctuations). In one embodiment, the property of the object is a material property such as, for example, the homogeneity or anisotropy of the object.

The second ray is propagated away from the surface, through at least one part of the object. The direction of the second ray may, for example, be determined by the vector normal to the surface at the point of intersection with the first ray (e.g., a ray in the direction opposite that of the vector, a bundle of rays that enclose defined angles to the normals). Step by step, values associated with the characteristic variable are determined on the second ray. The values on the second ray may be the values of the variable. In one embodiment, the value of the gradients of the variable are determined, for example, as a measure of fluctuations.

Using the second ray, the quantitative value that characterizes a property of the object is determined. The second ray may, for example, be propagated until a termination criterion is satisfied. The termination criterion may be, for example, in the encountering of another surface (e.g., detected by absolute values or values of the gradients of values associated with the characteristic variable). Other criteria may also be used. For example, the homogeneity of a material may be investigated. The values obtained at each step are correlated with each other, and the procedure terminates when a predetermined value of the fluctuations is exceeded. During the termination, a refinement to more precisely determine the place where the termination criterion was fulfilled may be made. Accordingly, the quantitative value that characterizes the property of the object may be the length of the second ray or a variable determined from the lengths of the plurality of second rays.

The determined quantitative value is assigned a color value (e.g., an RGBA value), for example, using a transfer function. The transfer function may be defined according to at least one component of the object that is to be displayed. For example, the object may be the head of a living thing, and the transfer function may be defined with the aim of displaying arteries for an essentially transparent representation of the top of the skull.

The methods of the present embodiments may be continued after the propagation of the second ray, in that the first ray is propagated further from the surface. After encountering another surface, the propagation of another second ray may be effected. The propagation of the first ray may be terminated when, in the context of the further propagation of the ray, a significant contribution to the color value for the pixel is no longer found (e.g., because the object exhibits opacity in the direction of the further propagation).

The color value determined in the course of the propagation of the second ray is used for determining the pixel color value. The color value may be combined with other color values determined with the methods of the present embodiments using the first ray and/or further second rays, in order to show the pixel color value.

The present embodiments have the advantage that, using pixels, rays that take account, “on-the-fly,” of geometric or other properties of an object under investigation may be generated. This makes the methods of the present embodiments less resource intensive than conventional methods.

### BRIEF DESCRIPTION OF THE DRAWINGS

FIG. 1 shows a schematic representation of ray-casting;

FIG. 2 shows a flow diagram for one embodiment of a method for visualizing an object using simulated radiation;

FIG. 3 shows one embodiment of a method for finding the position of a surface;

FIG. 4 shows one embodiment of a method for determining the thickness of an object;

FIG. 5 shows two images of objects visualized using one embodiment of a method for visualizing an object using simulated radiation; and

FIG. 6 shows one embodiment of a hardware structure for carrying out one embodiment of a method for visualizing an object using simulated radiation.

### DETAILED DESCRIPTION OF THE DRAWINGS

In one embodiment, images that visualize geometric properties of an object (e.g., as part of the coloring of surfaces as a function of the thickness of underlying structure of the object) are generated using a color palette.

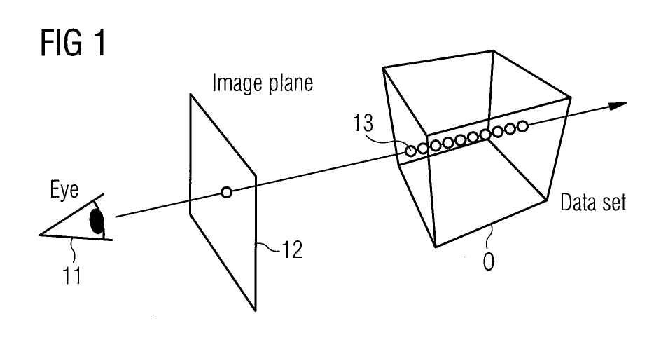

FIG. 1 shows the principle of volume-ray-casting, as it is currently used. Rays are transmitted from a virtual eye 11 through each pixel of a virtual image plane 12. Points on the rays are sampled at discrete positions (e.g., first position 13) within a volume or an object O. A plurality of sample values is combined to form a final pixel color.

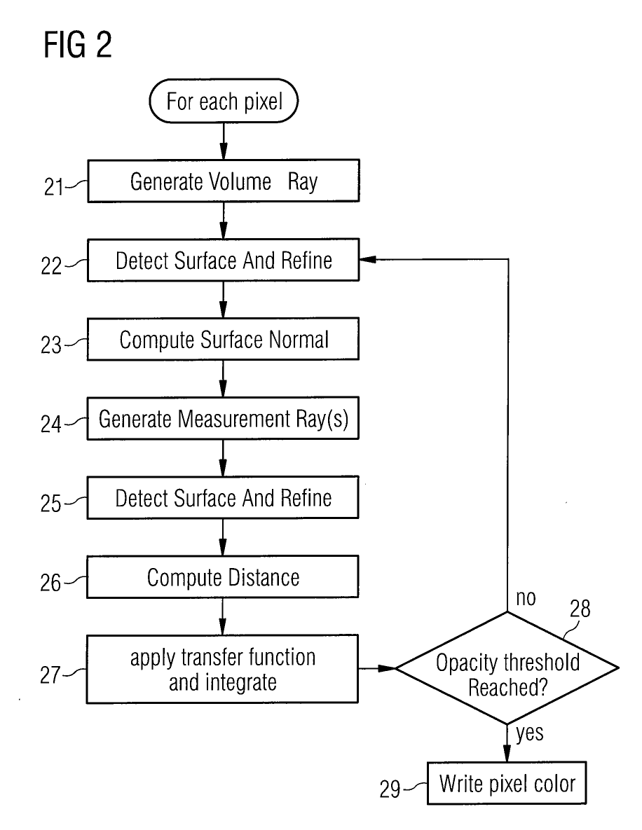

FIG. 2 shows a flow diagram for one embodiment of a method for generating images from volume data, taking into account geometry data determined during the method for generating images. As in the case of the standard volume-ray-casting procedure, a ray is generated for each pixel in the image plane (act 21), the ray starting at a virtual eye position (cf. FIG. 1). Using the rays, the interior of the object is sampled. An internal or an external surface of the volume data is detected (act 22). This is done, for example, by a threshold value method or by the detection of locally high gradient values in the volume data. A binary search may be used to determine the position of the surface with sub-voxel accuracy or a higher accuracy than the sampling step length of the ray.

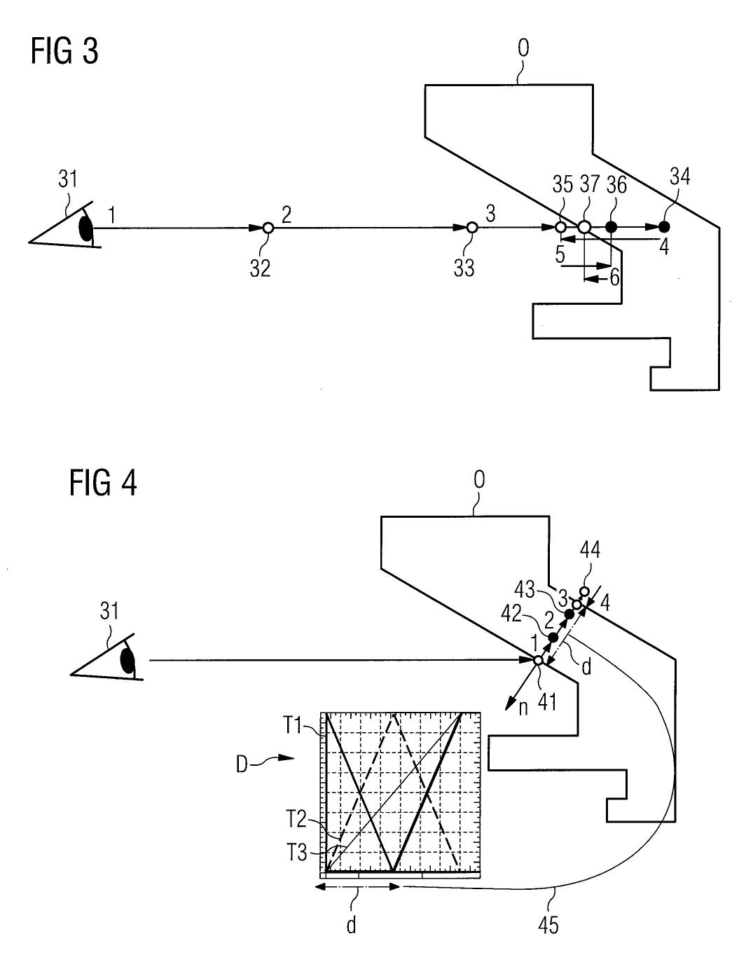

FIG. 3 illustrates one embodiment a method for determining a surface position with higher accuracy. The starting point is an imaginary eye 31, away from which the ray is propagated. The ray reaches positions 32, 33 and 34. Between position 33 and position 34, the ray penetrates into the object O. From density values at voxels in the object, density values are calculated for individual sample points at positions 31, 32, 33. At sample point 33, the density value is zero, because the sample point 33 is still located outside the volume O. At sample point 34, the density value has changed greatly. The change is recognized, and a refining process is thereby triggered. The sample point 35, which lies between the sample points 33 and 34, is sampled. Calculation of the density at sample point 35 shows that sample point 35 lies outside the object O. Point 36, which is located in the middle between sample points 35 and 34, is sampled. The point 36 lies inside the object, as may be determined from the density. In the course of this interval nesting, the site of the surface has been determined as lying between the points 35 and 36. The mean value of this interval is taken as an approximation for the site of the surface (e.g., point 37). This shows how the determination of the site of the entry point of the ray into the surface is made more accurate with a type of interval nesting.

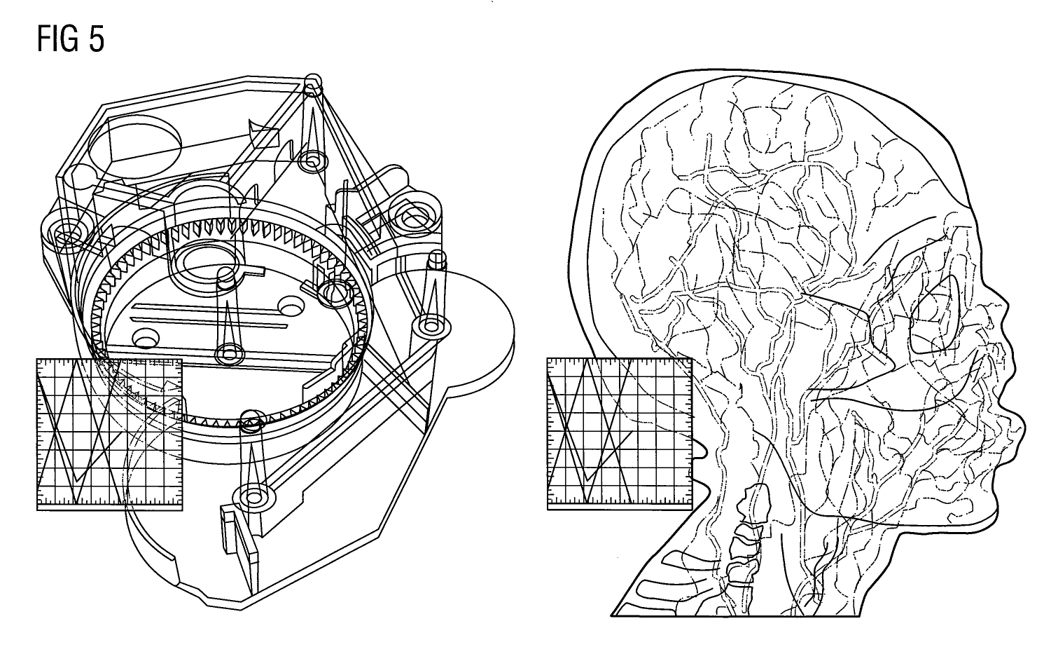

FIG. 3 shows how act 22 in FIG. 2 may be executed. As shown in FIG. 2, the normal to the surface is calculated, and a test ray is generated (acts 23 and 24, respectively). This is illustrated in more detail in FIG. 4. Starting out from an entry point 41, the normal n to the surface is determined, and a test ray is propagated in the opposite direction. The test ray is used to calculate the thickness of the object O at the entry point 41 (act 24 in FIG. 2). The test ray includes sample points 42, 43 and 44. Once again a change in density from sample point 43 to sample point 44. As in FIG. 3, a refined search is made for the position of emergence of the test ray out of the surface to obtain a value for the thickness d of the object O at the position of emergence. These acts are labeled in FIGS. 2 as 25 and 26. In other words, the rear surface is detected, and the position of the rear surface or thickness d is calculated. An arrow 45 indicates that the thickness d is used as input for a transfer function, which assigns a color and an opacity (e.g., an RGBA value) to the thickness d. In the lower part of FIG. 4, a diagram D shows three different transfer functions T1 to T3. The thickness that has been determined is shown on the X-axis, and the corresponding transparency or transparency value is shown on the Y-axis. The thickness d that has been calculated is shown in Diagram D. Depending on which transfer function is chosen, T1 to T3, the surface in the display will be transparent, or opaque or non-transparent, as appropriate. By a suitable choice of transfer function, properties of the object O under investigation may be better visualized. The color value (RBGA value) obtained is combined (e.g., by alpha blending) with the color value obtained from the ray-casting, as act 27 in FIG. 2 shows. The propagation of the original ray-casting ray may be terminated if the further sample points achieve no further contribution to the pixel, because the ray does not penetrate that far. This is represented by the query 28 in FIG. 2; if the threshold value for opacity is reached, the pixel calculation is concluded, and the pixel color may be stored away for the display (act 29). Otherwise, the ray-casting is continued until a new surface is found and any contribution from this surface to the pixel is determined using the same method as above.

FIG. 5 shows two examples of objects that have been investigated using a method of the present embodiments. The thickness of structures within the object is visualized. With the transfer function used in FIG. 5 (e.g., white curve in the diagrams), structures with average thickness are displayed as transparent. This is achieved by using appropriately low alpha values. The advantage is to be seen, for example, on the right of the image. Because the top of the skull and the arteries within a human head have a comparable thickness, the two are difficult to distinguish with conventional ray-casting. The display shown uses the different thicknesses (e.g., small thickness of arteries and average thickness of the top of the skull) to achieve a better visualization of the arteries.

The method permits not only the detection of secondary or internal surfaces within the same volume data set, but also exploration for secondary surfaces within combined volumes. Test rays are propagated from a primary surface in the main volume into the adjoining volume to detect a surface in the adjoining volume. This may be used for the visualization of fluctuations (e.g., in the densities of different components in industrial CT applications) or for pre- and post-operative comparisons in medical visualization methods.

The present embodiments of the method for generating images from volume data may be implemented in various forms by hardware, software, firmware, special purpose processors or a combination of these. The present embodiments may be implemented on a graphics processing unit (GPU) using open graphics library (OpenGL) and the OpenGL Shading Language.

The present embodiments of the method for generating images from volume data may be implemented in software as an application program. The application program may be uploaded to and executed on a machine having any suitable architecture.

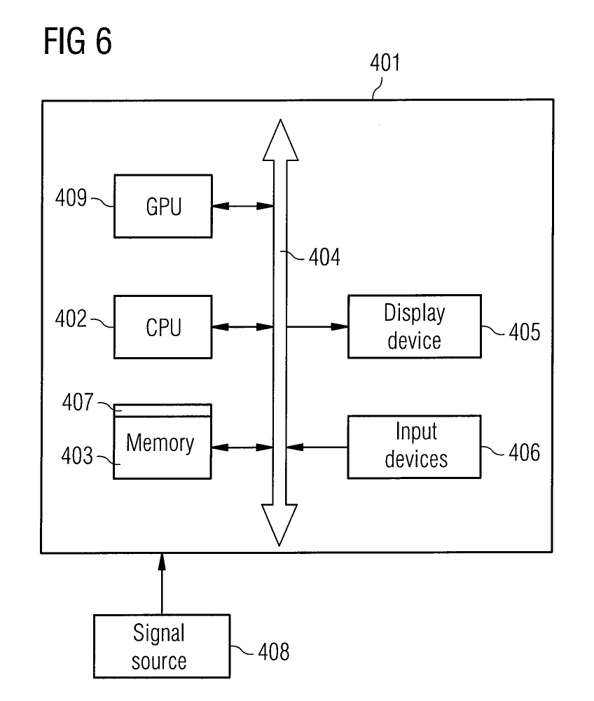

Referring to FIG. 6, one embodiment of a computer system 401 for GPU-based ray-casting may have a central processing unit (CPU) 402, a memory 403, and an input/output (I/O) interface 404. The computer system 401 may be linked via the I/O interface 404 to a display device 405 and various input devices 106 such as, for example, a mouse or a keyboard. Supplementary circuits may, for example, include circuits such as a cache, power supply, clock circuits and a communications bus. The memory 403 may include a read/write memory (random access memory, RAM), a read-only memory (ROM), a diskette drive, a tape drive, or a combination thereof. The present embodiments may be implemented as a program routine 407 that is stored in the memory 403 and is executed by the CPU 402 to process the signal from the signal source 408. In addition, the computer system 401 incorporates a graphic processing unit (GPU) 409 that has image data for processing graphics instructions (e.g., for processing the signal source 408). As such, the computer system 401 is a general multi-purpose computer system that becomes a special-purpose computer system when the computer system 401 executes the program 407 of the present embodiments.

The computer system 401 also contains an operating system and micro-instruction code. The various methods and functions described herein may either be a part of the micro-instruction code or may be part of the application program (or a combination thereof), which is executed by the operating system. Various other peripheral devices such as, for example, an additional data storage device and a printing device may be connected to the computer system 401.

Because some of the individual system components and acts of the method, which are shown in the attached figures, may be implemented in software, the actual links between the system components (or between the process acts) may be different, depending on the way in which the present embodiments are programmed

The invention is not restricted to the cases described above. The methods of the present embodiments may be used for virtual displays in fields quite different from medical technology or component testing. Other examples are the visualization of products in the context of business and trade, and computer games.

While the present invention has been described above by reference to various embodiments, it should be understood that many changes and modifications can be made to the described embodiments. It is therefore intended that the foregoing description be regarded as illustrative rather than limiting, and that it be understood that all equivalents and/or combinations of embodiments are intended to be included in this description.

1. A method for visualizing an object using simulated radiation, the method including:
using a representation of the object, in which values of a variable that characterizes the object are given at spatial points in the object;
generating a first ray to determine a pixel color value assigned to a pixel for a two-dimensional representation of the object;
propagating the first ray through at least a part of the object;
determining values of the variable on the first ray;
detecting a surface of the object using the values determined on the first ray;
generating a second ray to determine a quantitative value that characterizes a property of the object;
propagating the second ray away from the surface through at least a part of the object;
determining values associated with the variable on the second ray;
determining the quantitative value that characterizes the property of the object using the second ray;
assigning a color value in accordance with the quantitative value; and
using the color value to determine the pixel color value.

2. The method as claimed in claim 1, wherein the variable is a density of the object.

3. The method as claimed in claim 1, further comprising assigning a color value for the determined variable.

4. The method as claimed in claim 1, further comprising detecting the surface, refined in terms of a step size used in determining values of the variable on the first ray.

5. The method as claimed in claim 1, further comprising defining a direction of propagation of the second ray according to the vector normal to the surface.

6. The method as claimed in claim 1, wherein the second ray is propagated until a termination criterion is satisfied.

7. The method as claimed in claim 6, wherein the termination criterion is defined in accordance with the value of the variable.

8. The method as claimed in claim 1, wherein the quantitative value that characterizes the property of the object is a length.

9. The method as claimed in claim 8, further comprising determining a length, refined with respect to the step size used in determining the values associated with the variable on the second ray.

10. The method as claimed in claim 1, wherein assigning the color value in accordance with the quantitative value comprises using a transfer function, and
wherein the transfer function is determined in accordance with at least one component of the object that is to be displayed.

11. The method as claimed in claim 10, wherein the object is the head of a living being, and
wherein the transfer function is defined to display arteries for an essentially transparent representation of the top of the skull.

12. The method as claimed in claim 1, wherein the propagation of the first ray is continued from the surface after the propagation of the second ray.

13. The method as claimed in claim 12, wherein propagating the second ray comprises propagating the second ray repeatedly.

14. The method as claimed in claim 1, wherein the propagation of the first ray is terminated when no significant contribution to the color value of the pixel is determined.

15. The method as claimed in claim 1, wherein using the color value comprises combining assigned color values to determine the pixel color value.

16. A device for visualizing an object using simulated radiation, the device comprising:
a computer system, the computer system configured to:
use a representation of the object, in which values of a variable that characterizes the object are given at spatial points in the object;
generate a first ray to determine a pixel color value assigned to a pixel for a two-dimensional representation of the object;
propagate the first ray through at least a part of the object;
determine values of the variable on the first ray;
detect a surface of the object using the values determined on the first ray;
generate a second ray to determine a quantitative value that characterizes a property of the object;
propagate the second ray away from the surface through at least a part of the object;
determine values associated with the variable on the second ray;
determine the quantitative value that characterizes the property of the object using the second ray;
assign a color value in accordance with the quantitative value; and
using the color value to determine the pixel color value; and
use the color value to determine the pixel color value.

17. A non-transitory computer program product with a computer program for visualizing an object using simulated radiation by a processor, the computer program being configured for:
using a representation of the object, in which values of a variable that characterizes the object are given at spatial points in the object;
generating a first ray to determine a pixel color value assigned to a pixel for a two-dimensional representation of the object;
propagating the first ray through at least a part of the object;
determining values of the variable on the first ray;
detecting a surface of the object using the values determined on the first ray;
generating a second ray to determine a quantitative value that characterizes a property of the object;
propagating the second ray away from the surface through at least a part of the object;
determining values associated with the variable on the second ray;
determining the quantitative value that characterizes the property of the object using the second ray;
assigning a color value in accordance with the quantitative value; and
using the color value to determine the pixel color value.

18. The device as claimed in claim 16, wherein the variable is a density of the object.

19. The device as claimed in claim 16, wherein the device is configured to propagate the second ray until a termination criterion is satisfied.

20. The device as claimed in claim 19, wherein the termination criterion is defined in accordance with the value of the variable.
